(19) United States
(12) Patent Application Publication
(10) Pub. No.: US 2011/0282911 A1
(43) Pub. Date: Nov. 17, 2011

(54) METHOD AND APPARATUS FOR PROVIDING A RELATIONAL DOCUMENT-BASED DATASTORE

(75) Inventors: SERGIO SALVATORE, UNION CITY, NJ (US); MICHAEL CONCANNON, WESTFIELD, NJ (US); TIM NILSON, NEW YORK, NY (US)

(73) Assignee: Sony Corporation, Tokyo (JP)

(21) Appl. No.: 12/951,576

(22) Filed: Nov. 22, 2010

Related U.S. Application Data
(60) Provisional application No. 61/334,890, filed on May 14, 2010.

(51) Int. Cl. G06F 17/30

(52) U.S. Cl. 707/792; 707/E17.045

(57) ABSTRACT

A method and apparatus for implementing a relational document-based datastore are disclosed. Embodiments of the method comprise providing an interface for an application, performing relationship definition operations to define a one or more relationships between one or more documents contained within a set of data, interfacing with a datastore, and indexing the one or more documents and the one or more relationships. The apparatus comprises means for providing an interface for an application, means for performing relationship definition operations to define a one or more relationships between one or more documents contained within a set of data, means for interfacing with a datastore, and means for indexing the one or more documents and the one or more relationships.

### CROSS-REFERENCE TO RELATED APPLICATIONS

This application claims priority to U.S. Provisional Patent Application Ser. No. 61/334,890, filed May 14, 2010, which is incorporated by reference herein in its entirety.

### BACKGROUND

1. Field of the Invention

Embodiments of the present invention generally relate to data storage and retrieval techniques and, more particularly, to a method and apparatus for providing a relational document-based datastore.

2. Description of the Related Art

Databases are generally found in two major flavors: relational and hierarchical. Relational databases are based on the properties of relational algebra and involve breaking up the represented data (objects) into two-dimensional tables with columns and rows. A data-modeler's job is to analyze the different types of data to be stored in the database and normalize the properties of the data or objects so that the database can operate efficiently. This process of data modeling results in the creation of a schema that describes the types of objects that the database can store. Traditionally each object is assigned to a table, which stores a primary key (to identify that instance of the object uniquely) along with other principal information in each row. To describe the relationship between the objects, foreign keys are added to the tables that link rows from each table together. Relational databases use specific database languages, such as the Structured Query Language (SQL) as the interface for accessing and manipulating data. Modern databases often implement other concepts like indexing, triggers, stored procedures, etc. to make their use by developers easier.

While relational databases are particularly well suited to handle data that is inherently relational, they can be cumbersome to use when modeling data that has significant depth, requiring multiple tables and keys to model nested data. Also, making changes to the schema, as new types of objects need to be added, can be difficult to manage and involve system downtime.

While early implementations of hierarchical databases lacked speed and stability and were spurned in favor of their relational counterparts, such databases have recently gained widespread attention thanks to their ease of use and superior performance. Hierarchical databases are not founded on relational algebra. Rather, data modeling in a hierarchical database is a simpler process. While analyzing the types of objects is still necessary, the hierarchical model generally does not have a concrete schema that all objects must adhere to. Hierarchical databases typically provide data in a straightforward manner, similar to the way which users perceive relationships between objects (An album has a title and a series of tracks, tracks have titles and durations, etc.). As a result, new types of data can be added to the system with ease. However, due to the lack of reliance on relational algebra, traditional relational database languages such as SQL cannot be used with typical hierarchical databases.

Normalization can be an issue in a hierarchical database because data is necessarily duplicated where a reference would be used in a relational database. This results in complicated data manipulation exercises. While relationships between different objects can be stored in hierarchical databases, their presence is not treated as a “first class” property and must be interpreted by the application accessing the data. Thus, maintaining the relationship between objects becomes the burden and responsibility of the application where it may seem more natural to have the database manage it directly.

It would be preferable to use a system that can easily store data that contains depth, such as a hierarchical database, while automatically maintaining relationships between the data. Therefore, there is a need in the art for a relational document-based datastore.

### SUMMARY OF THE INVENTION

Embodiments of the present disclosure generally disclose methods and an apparatus for implementing a relational document-based datastore. In some embodiments, the method comprises providing an interface for an application, performing relationship definition operations to define a one or more relationships between one or more documents contained within a set of data, interfacing with a datastore, and indexing the one or more documents and the one or more relationships.

In some embodiments, the method comprises providing an interface for an application using a computer, performing relationship definition operations using a computer to define a one or more relationships between one or more documents contained within a set of data, interfacing with a datastore using a computer, and indexing the one or more documents and the one or more relationships using a computer.

In some embodiments, the apparatus comprises means for providing an interface for an application, means for performing relationship definition operations to define a one or more relationships between one or more documents contained within a set of data, means for interfacing with a datastore, and means for indexing the one or more documents and the one or more relationships.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a computer implementing a relational document-based datastore in accordance with embodiments of the present invention;

FIG. 2 depicts a system for implementing a relational document-based datastore in accordance with embodiments of the present invention;

FIG. 3 depicts a block diagram of a relational document-based data model in accordance with embodiments of the present invention;

FIG. 4 depicts an exemplary set of data objects and relationships between said data objects in accordance with embodiments of the present invention; and

FIG. 5 depicts a method for providing a relational document-based datastore in accordance with embodiments of the present invention.

### DETAILED DESCRIPTION

As explained further below, various embodiments of the invention provide a relational document-based datastore. The terms “database” and “datastore” can be interchangeably used within the specification without departing from the meaning and scope of the invention.

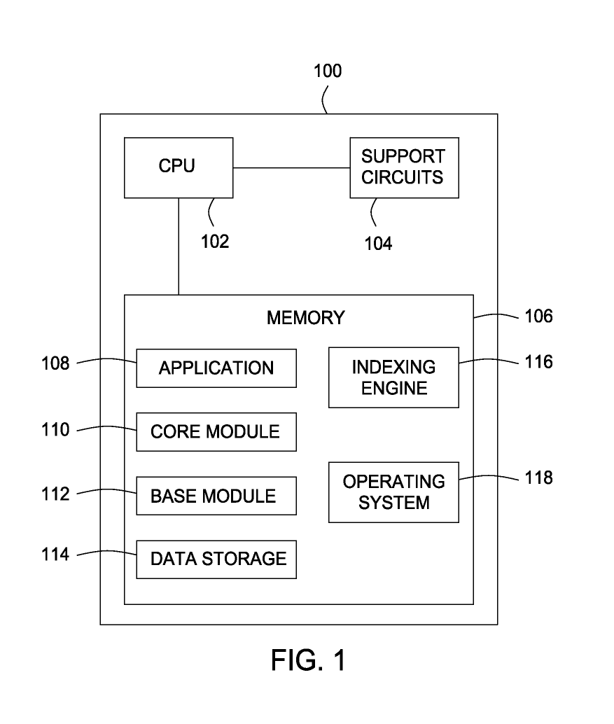

FIG. 1 is a block diagram depicting a computer system in accordance with embodiments of the present invention. The computer 100 comprises a general purpose computer that operates as a specific purpose computer for the purpose of implementing a relational document-based datastore. The computer executes a core module 110, a base module 112, a data storage module 114, and an indexing engine 116 to perform embodiments of the present invention. The computer 102 may operate as a server for a network (not pictured) and one or more clients (not pictured). In operation, the computer 100 performs data access operations necessary to implement access to data contained within a datastore implemented in accordance with embodiments of the present invention.

The general purpose computer is a computing device such as those generally known in the art. While the present exemplary embodiment is discussed with respect to a single computer 100, one of ordinary skill in the art would recognize that the various aspects and modules of the invention could be implemented as multiple computer systems connected via a network. The computer 100 includes a central processing unit (CPU) 102, support circuits 104, and memory 106. The CPU 102 may comprise one or more commercially available microprocessors or microcontrollers that facilitate data processing and storage. The various support circuits 104 are utilized to facilitate the operation of the CPU 102 and include such circuits as clock circuits, power supplies, cache, input/output circuits and devices, and the like. The memory 106 may comprise random access memory, read only memory, removable storage, flash memory, optical disk storage, disk drive storage, and combinations thereof. The memory 106 stores an application 108, a core module 110, a base module 112, a data storage module 114, an indexing engine 116, and an operating system 118. In operation, the CPU 102 executes the operating system 118 to control the general utilization and functionality of the computer.

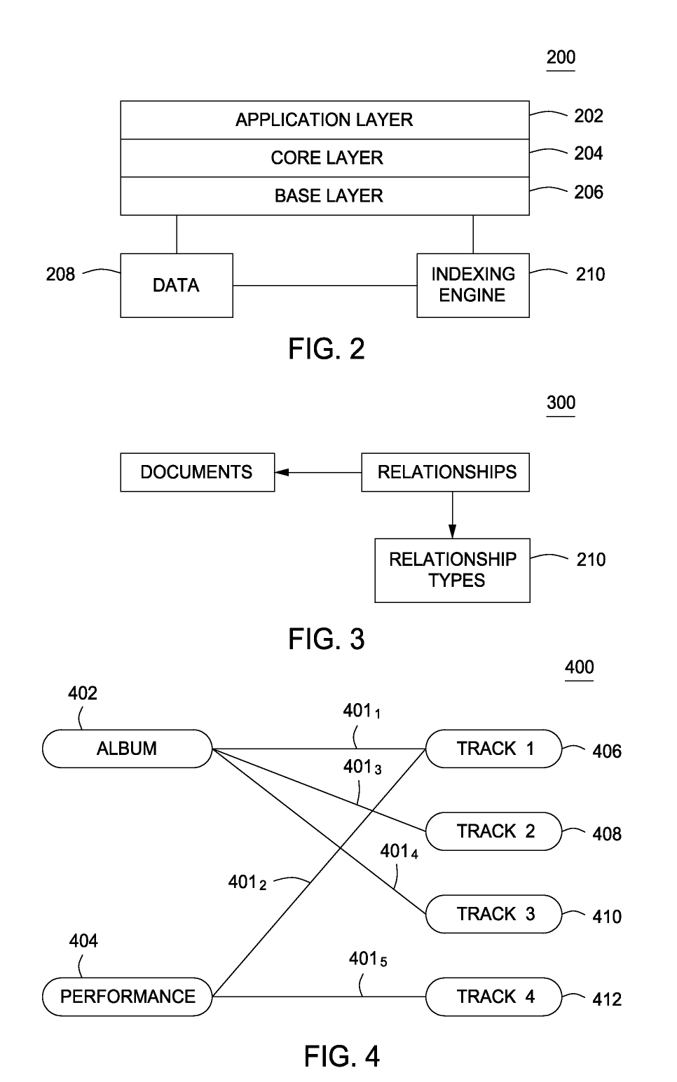

The memory 106 is further comprised of an application 108. The application 108 utilizes the core module 110 to access a set of data contained within the data storage 114. In operation, the base module 112 and indexing engine 116 interface with the core module 110 and data storage 114 to facilitate access of the data contained within the data storage 114. The interaction among these components is discussed further with respect to FIG. 2. The application 108 itself may be any application that is capable of interfacing with a database. Common examples of such applications include stores, inventory control systems, catalogs, and other applications which may have use of a data repository where objects within a data repository are related to one another.

FIG. 2 depicts a block diagram of a system 200 used to implement a relational document-based datastore in accordance with embodiments of the present invention. The system 200 comprises an application layer 202, a core layer 204, a base layer 206, a set of data 208, and an indexing engine 210.

The application layer 202 allows an application (such as the application 108 discussed with respect to FIG. 1) to interface with the relational document-based datastore. In some embodiments, this interface is provided as an application programming interface (API) to facilitate the interaction with the core layer 304.

The core layer 204 performs relationship definition operations to define relationships between objects contained within the data 208. An example of the core layer 204 in operation is the core module 110 discussed with respect to FIG. 1. In a traditional relational database, the functions provided by the core layer would be performed by a database administrator (DBA) responsible for maintaining and optimizing the table structure of the data 208. The core layer 204 further allows for modification of the datastore schema to modify the types of objects that the datastore can store. The object relationships are discussed further with respect to FIG. 3.

In some embodiments, the core layer 204 is implemented in an interpreted object-oriented language (e.g. RUBY), and is run using a particular runtime designed for the particular interpreted language (e.g. JRUBY) within a virtual machine (e.g. JAVA VIRTUAL MACHINE). The use of the virtual machine and runtime in this manner allows for direct access to classes provided by the base layer 206. Using the interpreted language in this manner allows developers to write code in a higher level language (such as RUBY), while realizing performance gains associated with the lower level language of the virtual machine. The base layer 206 performs database access operations, such as create, read, update, and delete (CRUD) operations, searching, caching, and the like. The base layer 206 provides a thin wrapper around the database operations, abstracting database language (such as MySQL) access from the core layer 204 and the application layer 202.

The base layer 206 implements a cache function to increase datastore performance. In one specific embodiment, a caching engine such as EHCACHE is used to implement a cache. An in-memory hash by a primary key (e.g. the universal id associated with each document) allows the vast majority of document lookups to bypass database language operations entirely, taking advantage of high speed system memory access times. Simple “write-through” semantics are used where modifications to the data are managed by the core layer 204 which updates the cache and then persists the changes to the data 208. Because of the relationship lookup operations as discussed further with respect to FIG. 3, the datastore has a high read-to-write ratio, which allows extremely fast access times and traversal of complex relationship graphs with ease by using the cache engine. An example of the base layer 206 in operation is the base module 112 discussed with respect to FIG. 1. The base layer 206 interfaces with the data 208 and the indexing engine 210.

The data 208 represents the information contained within the objects of the datastore and the relationships between said objects. The data 208 is generally comprised of three separate data tables, a document table, a relationship table, and a relationship types table. In some embodiments, the data 208 is implemented as a traditional relational database, such as provided by MYSQL. Such a traditional relational database performs standard database maintenance and cleanup operations such as garbage collection, concurrency tracking, and the like. The interaction of these three tables is discussed further with respect to FIG. 3.

The indexing engine 210 is a module used for searching within the data 208. The indexing engine 210 allows for access to a particular set of data representing documents and relationships. The indexing engine 210 is necessary because the values of the objects within the data 208 are stored opaquely to the datastore. The indexing engine 210 provides the ability to search the contents of the database by a property other than a primary key (e.g. a text string).

FIG. 3 depicts the three data tables 300 contained within the data 208. The data tables are a document table 302, a relationships table 304, and a relationship types table 306. The core layer 204 uses the data defined within the three data tables to synthesize objects and the relationships between them. The document table 302 comprises a set of abstract objects requiring a universally unique primary key and type. In some embodiments, principle information associated with each document is stored in a flexible structure tied directly to the document (e.g. extensible markup language or JAVASCRIPT object notation (JSON)). Each document object is represented by a universal identifier. Storing documents in a universal ID space in this manner allows for a relationship to be made from any type of document to any type of document. In some embodiments, each document object is associated with an identifier, a type, a JSON identifier, a creation time, a last-updated time, and a set of flags for particular properties. The document type defines which properties of the document should be indexed by the indexing engine, including properties of related documents.

The relationship table 304 comprises a set of logical relationships between two documents. The relationship is defined by a relationship type and a position to provide sequencing when multiple documents are related with the same relationship type. In some embodiments, the each relationship is defined by an identifier, a source document identifier, a destination document identifier, a relationship type identifier, a position, a creation time, and a last-updated time.

The relationship type table 306 comprises data describing each type of relationship that is possible between two documents. In some embodiments, each relationship type is defined by an identifier, a source class, a source name, a source direction, a destination class, a destination name, a destination direction, a creation time, and a last-updated time.

FIG. 4 is an exemplary embodiment of set of objects and relationships 400 located within a relational document-based datastore. This particular example comprises an album object 402, a performance object 404, a track 1 object 406, a track 2 object 408, a track 3 object 410, and a track 4 object 412 and a set of relationships 401₁, . . . 401₅. In the present example, both the album object 402 and the performance object 404 have relationships 401 to objects of the type “track.” In particular, the album object 402 is related to the track objects 406, 408, and 410, while the performance object 404 is related to the track objects 406 and 412.

The exemplary datastore 300 the present invention must only perform a table lookup operation to define the relationships between objects, and then a table lookup to access the objects themselves. In this manner, the relationships between objects are treated as a “first-class” property such that the accessing application does not need to perform interpretation or dereferencing operations. The entire process is transparent from the perspective of the application layer.

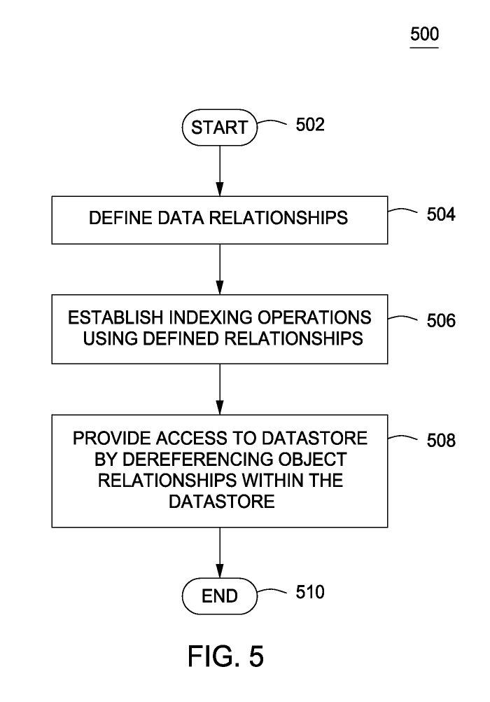

FIG. 5 depicts a flow diagram for a method 500 implementing a relational document-based database in accordance with embodiments of the present invention. The method begins at step 502 and proceeds to step 504. At step 504, a set of data relationships is defined, such as the relationships between objects within the datastore. The method then proceeds to step 506.

At step 506, a set of indexing operations for the datastore is established based upon the defined relationships as defined at step 504. The indexing operations are then used to facilitate access to the data within the datastore. Once the indexing operations are established, the method proceeds to step 508.

At step 508, the method provides access to objects within the datastore using the indexing operations established at step 506. When a data request is made, the datastore determines the type of data object being requested and constructs the object from the associated documents and document relationships contained within the database. For example, in an exemplary embodiment, a search for a CD is performed in response to a request from a source application. The search may be performed by entering some lyrics from a song on the album.

Prior to the search, the datastore is supplied with definitions of one or more fields to be indexed. In the present example, the document type “Compact Disc” defines which properties should be indexed, including properties of related documents such as the text of a “lyrics” document which is related to a “track” document related to this compact disc document.

The search is then performed on this inverted index (supplied by, for example, the indexing engine 210) to find a list of matching documents identifiers form the universal ID space. The document data may be loaded from the cache as provided by the core layer 204 at a low computational cost or retrieved from the permanent storage location. The document data is presented to the source application in the proper hierarchical form, matching the form in which it was stored.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

While the foregoing is directed to embodiments of the present invention, other and further embodiments of the invention may be devised without departing from the basic scope thereof, and the scope thereof is determined by the claims that follow.

1. A method for implementing a relational document-based datastore comprising:
defining a set of data relationships using a computer;
establishing a set of indexing operations using the set of data relationships using a computer; and
providing access to the datastore using a computer by dereferencing a set of object relationships between data objects within the datastore, wherein the dereferencing operations occur transparently to an application accessing the datastore.

2. The method of claim 1 wherein the datastore comprises a document data table, a relationship data table, and a relationship types data table.

3. The method of claim 2 wherein the document data table, relationship data table, and relationship types data table are implemented as a relational database.

4. The method of claim 2, wherein the data relationships are defined within the document data table, the relationship data table, and the relationship types data table.

5. The method of claim 1, wherein the establishing step further comprises modifying the schema for the datastore to alter the type of data the database can store.

6. The method of claim 1, further comprising:
providing caching operations which allow document lookups to bypass database language operations by using an in-memory hash from a primary key.

7. A method for implementing a relational document-based datastore comprising:
providing an interface for an application using a computer;
performing relationship definition operations using a computer to define a one or more relationships between one or more documents contained within a set of data;
interfacing with a datastore using a computer; and
indexing the one or more documents and the one or more relationships using a computer.

8. The method of claim 7, further comprising storing a set of data within the datastore wherein the data is represented by a set of three tables, wherein the three tables comprise a document table, a relationships table, and a relationship types table.

9. The method of claim 8, wherein each element within the document table is represented by a universal identifier.

10. The method of claim 7, wherein the one or more relationships between the one or more documents are contained within the relations table.

11. The method of claim 10, wherein the relationship types table comprises a set of possible types of relationships.

12. An apparatus for implementing a relational document-based datastore comprising:
means for providing an interface for an application;
means for performing relationship definition operations to define a one or more relationships between one or more documents contained within a set of data;
means for interfacing with a datastore; and
means for indexing the one or more documents and the one or more relationships.

13. The apparatus of claim 12, further comprising means for providing data storage including data maintenance and cleanup operations.
